(19) United States
(12) Patent Application Publication
(10) Pub. No.: US 2008/0022328 A1
(43) Pub. Date: Jan. 24, 2008

(54) Method and system for providing interactive virtual tablecloth

(76) Inventor: Robert R. Miller, Convent Station, NJ (US)

Correspondence Address: AT&T CORP., ROOM 2A207, ONE AT&T WAY, BEDMINSTER, NJ, 07921, US

(21) Appl. No.: 11/478,820

(22) Filed: Jun. 30, 2006

(51) Int. Cl. H04N 7/173; G06F 13/00; H04N 7/20; H04N 5/445

(52) U.S. Cl. 725/86; 725/63; 725/37; 725/87; 725/42

(57) ABSTRACT

A method and system for providing an interactive virtual tablecloth. A server transmits various types of content, and a projector projects images corresponding to the transmitted content onto a display surface. For example, the display surface can be a table. The server receives control signals from at least one wireless client device, and adjusts the content based on the control signals. When a plurality of users share a common display surface, such as restaurant customers at a table, the display surface is divided into windows for each of the users. Each user can use a wireless client device to control his/her own window.

### BACKGROUND OF THE INVENTION

The present invention is directed to location based interactive services. More specifically, the present invention is directed to a method and system for providing a location based interactive virtual tablecloth for delivering various types of entertainment and informational content to users.

In a business that depends on customer service, such as restaurants, coffee shops, etc., it is important that customers have an enjoyable time while patronizing a particular business. For example, in restaurants, the “atmosphere” of the restaurant as well as the quality of the food and service can lead customers to return to the restaurant and/or recommend the restaurant to others. Thus, business owners must try to develop ways to provide enjoyment and convenience to their customers, while the customers are patronizing their businesses.

One such way of providing enjoyment and convenience to customers, is to provide location based Internet service to customers when customers are located in a particular place of business. For example, many restaurants, coffee shops, shopping malls, etc., provide a wireless data network for customers to access the Internet within the particular place of business. This allows Customers with wireless enabled devices, such as personal digital assistants (PDAs), laptop computers, and wireless cellular telephones to wirelessly connect to the Internet to view Internet content and check e-mail. While wireless Internet access provides a service to customers, it is desirable to provide customers with additional entertainment services as well.

### BREIF SUMMARY OF THE INVENTION

The present invention provides a system and method for providing entertainment services to users, such as customers or patrons of a business, in the form of an interactive virtual tablecloth. In a conventional wireless data network provided at a place of business, a business owner has no control over the content viewed by a user using the wireless data network. The present invention allows an administrator, such as a business owner, to provide different types of entertainment content to users. This gives users a variety of entertainment choices in addition to general Internet surfing. Furthermore, because a business owner provides content to the users, business owners can add to revenues by including advertising in the entertainment content and/or charging users to access certain content.

In one embodiment of the present invention, content is transmitted from a server. Images corresponding to the transmitted content are projected onto a display surface. The display surface may be, for example, a table. Control signals are received at the server via a wireless data network from at least one wireless client device, such as a personal digital assistant (PDA), a cellular telephone, and a laptop. The wireless client device transmits the control signals to the server via a wireless data network. The server adjusts the content, which is reflected in the images displayed on the display surface.

It is possible that a plurality of users can share a common display surface. For example, restaurant customers seated at a table share the common display surface of the table. In this case, content for each user is transmitted from the server. The content for each user is displayed in a respective window on the display surface, and each user can use a wireless client device to control the content displayed in the user's window on the display surface.

These and other advantages of the invention will be apparent to those of ordinary skill in the art by reference to the following detailed description and the accompanying drawings.

### BRIEF DESCRIPTION OF THE DRAWINGS

FIG. 1 illustrates a system for generating and controlling a virtual tablecloth according to an embodiment of the present invention;

FIG. 2 illustrates a high level block diagram of a computer capable of implementing the present invention;

FIG. 3 illustrates an exemplary virtual tablecloth system in a restaurant according to an embodiment of the present invention;

FIG. 4 illustrates a method of generating and controlling a virtual tablecloth according to an embodiment of the present invention;

### DETAILED DESCRIPTION

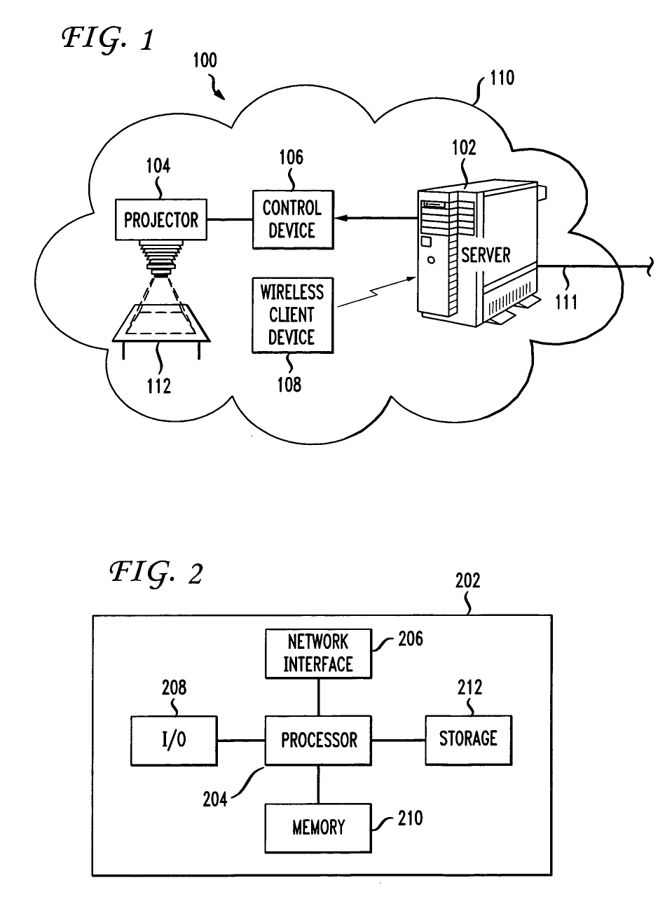

FIG. 1 illustrates a system 100 for generating and controlling a virtual tablecloth according to an embodiment of the present invention. As illustrated in FIG. 1, the system 100 includes a server 102, a projector 104, a projector control device 106, and a wireless client device 108. These elements are located close enough to each other that they are all in the range of a common local Wireless Local Area Network (WLAN) 110. An example of such as WLAN 110 is the IEEE 802.11 standard, commonly know as Wi-Fi.

WLAN 110 provides Ethernet-like radio connectivity within the area in which the virtual tablecloth(s) will operate. The server 102 provides various types of content to the projector control device 106. For example, the server 102 can store media such as movie content, television programming content, gaming content, music content, advertising content, and business specific content corresponding to a particular business at which the server 102 is located, and deliver this content to the projector control device 106. It is possible that the server streams some types of content, such as movies and television programs to the projector control device 106. Furthermore, the server 102 is connected to a data network, such as the Internet. The server connects to the WLAN 110, and may also connect to the Internet via an access network connection 111 comprised of a wireless Neighborhood Area Network, Metropolitan Area Network, cellular data network, or a wired broadband connection such as DSL, DOCSIS, or Fiber. Thus, the server 102 can transmit Internet content (i.e., web pages, etc.) to the projector control device 106. The server 102 can deliver the content to the projector control device 106 through a direct connection (e.g., a cable), or wirelessly.

The projector 104 projects images onto a display surface 112. In an embodiment of the present invention, the display surface 112 is a horizontal surface, such as a table, and the images projected from the projector 106 form a virtual tablecloth on the table. The projector 104 can be suspended above the display surface 112, or, if the display surface 112 is translucent, the projector 104 can project the images from below the display surface 112. The projector 104 can be implemented as, but is not limited to, one of a digital light processing (DLP) projector and a liquid crystal display (LCD) projector.

The projector control device 106 receives the content delivered by the server 102, and processes the content into images to be projected by the projector 104. For example, the projector control device 106 can be a computer connected to the projector 104. The projector control device 106 formats the images to be a size corresponding to a size of the display surface 112. The projector control device 106 can format an image to be a full size of the display surface 112, or can format an image to be a size of a portion of the display surface 112 such that when the projector 104 projects that image onto the display surface 112, that image is displayed as a window on a portion of the display surface 112. According to an embodiment of the present invention, the projector 104 is capable of multiplexing multiple images corresponding to different content received from the server 102 onto a common display surface 112 in order to display the images as multiple windows on the display surface 112.

The wireless client device 108 can be an 802.11 enabled portable device, such as a portable digital assistant (PDA), a cellular phone, a laptop computer, or the like. The wireless client device 108 connects to the Internet through the WLAN 110, and communicates with the server 102 through the Internet. The wireless client device 108 sends control signals to the server 102 in order to control the content being delivered by the server 102 to the projector control device 106 and thus, the images being projected on the display surface 112 by the projector 104. Thus, content being displayed on the display surface 112 can be selected and controlled by the wireless client device 108. In the case multiple images corresponding to different content are multiplexed onto the display surface 112, it is possible that a separate wireless client device can control the content corresponding to each of the multiple images.

The server 102 and the projector control device 106 may each be implemented on a computer using well known computer processors, memory units, storage devices, computer software, and other components. A high level block diagram of such a computer is illustrated in FIG. 2. Computer 202 contains a processor 204 which controls the overall operation of the computer 202 by executing computer program instructions which define such operation. The computer program instructions may be stored in a storage device 212 (e.g., magnetic disk) and loaded into memory 210 when execution of the computer program instructions is desired. Thus, content delivery applications of the server 102 or image formatting applications of the projector control device 104 can be defined by the computer program instructions stored in the memory 210 and/or storage 212 and will be controlled by the processor 204 executing the computer program instructions. Furthermore, different types of content, such as movies, television programming, advertising, and business related content can be stored in the storage 212 and/or the memory 210. The computer 202 also includes one or more network interfaces 206 for communicating with other devices via a network. The computer 202 also includes input/output 208 which represents devices which allow for user interaction with the computer 202 (e.g., display, keyboard, mouse, speakers, buttons, etc.) One skilled in the art will recognize that an implementation of an actual computer will contain other components as well, and that FIG. 2 is a high level representation of some of the components of such a computer for illustrative purposes.

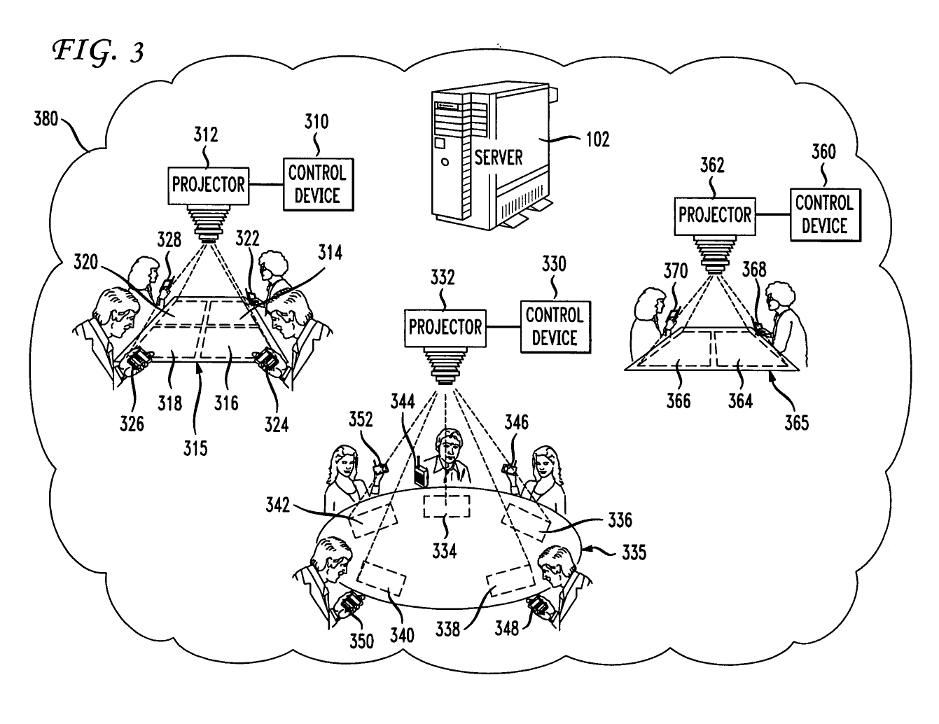

FIG. 3 illustrates an exemplary embodiment of the present invention, in which an interactive virtual tablecloth system is implemented in a restaurant. As illustrated in FIG. 3, a server 302 delivers content to multiple projector control devices 310, 330, and 360, each of which is connected to a projector 312, 332, and 362. Each projector 312, 332, and 362 projects images corresponding to the content delivered to the connected projector control device 310, 330, and 360 onto a table 315, 335, and 365, which acts as a display surface. The content delivered from the server 302 to the projector control devices 310, 330, and 360 and projected as images onto the tables 315, 335, and 365 can include business specific content for a restaurant such as an interactive menu, food-readiness tracking, bill tally, etc.

As illustrated in FIG. 3, each projector 312, 332, and 362 multiplexes a number of images onto the respective table 315, 335, and 365 corresponding to a number of customers (“users”) seated at the table 315, 335, and 365. For example the surface of table 315 is divided into four windows 314, 316, 318, and 320 corresponding to four customers seated at that table 315. Each customer at table 315 has a wireless client device 322, 324, 326, and 328 which communicates with the server 302 to control the content that is displayed on the corresponding window 314, 316, 318, and 320 of the table 315. Five windows 334, 336, 338, 340, and 342 are provided on the surface of table 335 corresponding to five customers seated at that table 335. Each customer at table 335 has a wireless client device 344, 346, 348, 350, and 352 which communicates with the server 302 to control the content that is displayed on the corresponding window 334, 336, 338, 340, and 342 of the table 335. The surface of table 365 is divided into two windows 364 and 366 corresponding to two customers seated at that table 365. Each customer at table 365 has a wireless client device 368 and 370 which communicates with the server 302 to control the corresponding window 364 and 366 on the table 365. The wireless client devices 322, 324, 326, 328, 344, 346, 348, 350, 352, 368, and 370 connect to the Internet wirelessly through a WLAN 380, and communicate with the server 302 through the WLAN 380. Using their respective wireless client devices 322, 324, 326, 328, 344, 346, 348, 350, 352, 368, and 370, the customers can select content to be viewed on their respective windows 314, 316, 318, 320, 334, 336, 338, 340, 342, 364, and 366, as well as interact with the content. Accordingly, the interactive virtual tablecloth can be used for restaurant services, such as ordering from the menu, viewing and paying the bill, etc, as well as entertainment services, such as watching movies or television programming, playing games, viewing Internet content, etc.

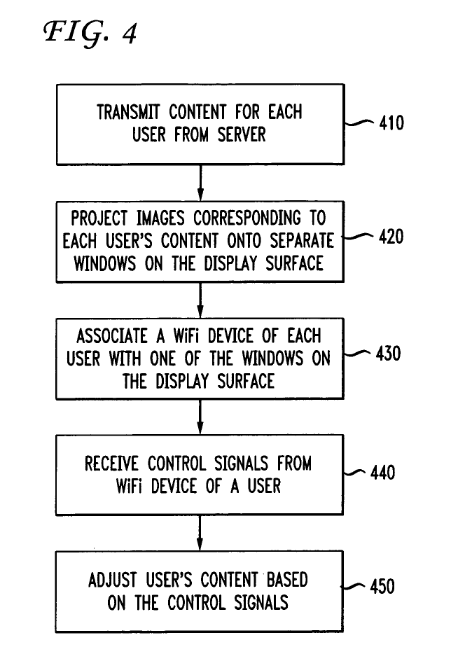

FIG. 4 illustrates a method of generating and controlling an interactive virtual tablecloth according to an embodiment of the present invention. As described herein, the method applies to a plurality of users at a common display surface, such as customers at a table in a restaurant, but the method can also be applied to a single user at a display surface. At step 410, content for each user is transmitted from a server to a projector control device. The number of users can be manually input to the server or be automatically sensed. For example, in the case of restaurant customers at a table, a waitress or hostess can enter the number of customers at a certain table when seating the customers, or the number of customers can be automatically sensed using weight sensors in the seats or some other sensing method. The server, upon receiving the number of customers can transmit initial content to each user, such as a default menu displaying options for types of content a user can view. For example, the default menu may include options for movies, games, Internet, and other entertainment content as well business related content, such as a restaurant menu, food readiness tracking, the user's bill, etc.

At step 420, images corresponding to each user's content are projected onto separate windows on the display surface. When the projector control device receives the content for each user, the projector control device process the content to generate corresponding images and transmits the images corresponding to each user's content to the projector. The projector multiplexes the different images corresponding to the different user's content onto a common display surface. For example, the display surface of a table can be evenly divided between the number of users seated at the table, such that a window is provided on the table for each user. Furthermore, the projector projects the images such that each window is positioned facing a correct direction with respect to one of the users. It is also possible that the a portion of the display surface, or a portion of each window is dedicated to advertising content, thus allowing a business owner to sell advertising and require that users view the advertising.

At step 430, a wireless client device of each user is associated with one of the windows on the display surface. This allows a particular wireless client device to control its associated window. Accordingly, each user has a window on the display surface that he/she can control using his/her wireless client device. In one embodiment of the present invention, the wireless client devices of the users are provided by a business (e.g., a restaurant) and are pre-assigned to a particular window of a display surface (e.g., a seat at a table). In another embodiment of the present invention, the users can use their own wireless client devices (e.g., PDA, cell phone, laptop). In this case, a user may access a map enabled program to associate a particular wireless client device with a particular window of a display surface. For example, the map enabled program may be a web page accessible on the wireless client device of a user and including a map of the restaurant where the user is located. The user can then select a table and a seat using the map on the web page. It is also possible, that the user be required to enter a code or password, possibly given to the user by a waitress or hostess, such that the user can only gain control over the window corresponding to his/her own seat.

At step 440, control signals are received at the server from a wireless client device of a user. The control signals can be signals corresponding to any action that a user wishes to carry out on the user's window, such as moving a cursor, select, enter, and other functions. For example, a user can use a wireless client device to select movie content from the default menu, and then pause, fast forward, rewind, etc., the movie content using the wireless client device. Similarly, a user can use a wireless client device to select gaming content from the default menu, and use the wireless client device as a game controller. Furthermore, if a user selects restaurant related content from the default menu, the user can than scroll through a restaurant menu, order from the restaurant menu, and pay the bill using the wireless client device (e.g., by entering a credit card or billing number using a secure shell).

At step 450, the user's content is adjusted based on the control signals received from the user's wireless client device. As used herein, “adjusting” the user's content refers to any change to the content or the corresponding images projected on the display surface. When the server adjusts the user's content based on the control signals, this adjustment is reflected in the images corresponding to the user's content that are displayed on the window of the display surface that is associated with the user's wireless client device.

As described above, according to embodiments of the present invention, a system administrator, such as a business owner, has control over what content is available to be viewed on local display surfaces (e.g., tables in a restaurant). This allows the system administrator to filter any content that he/she does not want being viewed, as well as tailor content to a specific audience. In addition, the system administrator controls the amount of advertising to be displayed on the display surface and the manner of displaying the advertising. This allows business owners to add additional revenues from advertising. Furthermore, it is possible that a business owner charge an additional fee for some content, such as gaming, movies, etc., to add additional revenues directly from the customers paying to view certain content.

Although embodiments of the present invention being implemented in a restaurant are described in detail above, these embodiments are purely exemplary, and the present invention is not limited thereto.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
transmitting content from a server;
projecting images corresponding to the transmitted content onto a display surface;
receiving control signals at the server via a wireless data network; and
adjusting the content based on the received control signals.

2. The method of claim 1, wherein said receiving step comprises:
receiving said control signals from at least one wireless client device via the wireless data network.

3. The method of claim 2, wherein said at least one wireless client device comprises at least one of a personal digital assistant (PDA), a cellular telephone, and a lap top computer.

4. The method of claim 1, wherein said display surface comprises a table.

5. The method of claim 1, wherein said transmitting step comprises:
transmitting content for each of a plurality of users.

6. The method of claim 5, wherein said projecting step comprises:
formatting the content for each of the plurality of users into separate images; and
multiplexing the separate images onto the display surface such that each of the separate images appears as a respective window on the display surface.

7. The method of claim 6, wherein said display surface comprises a table and each window on the display surface corresponds to seats at the table.

8. The method of claim 6, further comprising:
associating a wireless client device of each of the plurality users with one of the windows on the display surface.

9. The method of claim 8, wherein said receiving step comprises:
receiving control signals from at least one wireless client device via the wireless data network.

10. The method of claim 9, wherein said adjusting step comprises:
adjusting content corresponding to the images displayed on at least one window on the display surface associated with said at least one wireless client device.

11. The method of claim 1, wherein the content comprises at least one of movie content, gaming content, television content, music content, advertising content, and business related content.

12. The method of claim 1, wherein the content is obtained via the Internet.

13. The method of claim 1, wherein the content comprises an interactive restaurant menu.

14. The method of claim 13, wherein said receiving step comprises:
receiving control signals at the server via the wireless data network corresponding to at least one user ordering from the interactive menu.

15. A system comprising:
a server to transmit various types of content;
at least one display surface;
at least one projector to project images corresponding to the content transmitted from the server onto the at least one display surface; and
at least one wireless client device communicating with the server via a wireless data network to control the content transmitted by the server.

16. The system of claim 15, further comprising:
at least one projector control device connected with the at least one projector to receive the content transmitted by the server and to format the content into the images corresponding to the content.

17. The system of claim 15, wherein said at least one display surface comprises a plurality of tables, and said at least one projector comprises a plurality of projectors, each corresponding to one of the tables.

18. The system of claim 17, wherein said at least one wireless client device comprises a wireless client device for each of one or more users at each of the plurality of tables.

19. The system of claim 17, wherein each projector projects images to one or more windows on the corresponding table, the one or more windows corresponding to the one or more users at the table, and each wireless client device controls content corresponding to images projected on one of the windows.

20. The system of claim 15, wherein said projector comprises one of a digital light processing (DLP) projector and a liquid crystal display (LCD) projector.

21. The system of claim 15, wherein the at least one wireless client device comprises at least one of a personal digital assistant (PDA), a cellular telephone, and a lap top computer.

22. The system of claim 15, wherein said content comprises at least one of Internet content, movie content, gaming content, television content, music content, advertising content, and business related content.
